(19) United States
(12) Patent Application Publication
(10) Pub. No.: US 2012/0150992 A1
(43) Pub. Date: Jun. 14, 2012

(54) SYSTEM AND METHOD FOR PROVIDING COMPUTER SERVICES

(76) Inventors: Stephen Mark Mays, San Rafael, CA (US); Joseph Anthony Lovullo, JR., San Rafael, CA (US); Sandeep Cai, Tiburon, CA (US)

(21) Appl. No.: 13/261,133

(22) PCT Filed: Sep. 10, 2008
(86) PCT No.: PCT/US08/10592

§ 371 Date: Jan. 10, 2012

Related U.S. Application Data
(60) Provisional application No. 60/993,280, filed on Sep. 10, 2007.

(51) Int. Cl. G06F 15/16

(52) U.S. Cl. 709/217

(57) ABSTRACT

A computer system and method for providing computer services to a user, comprising: a virtual computer system comprising at least one virtual computer that is created within the virtual computer system; a virtualization layer enabling the at least one virtual computer to utilize CPU, RAM and storage of a host computer within the virtual computer system; a virtual computer selector providing for the selection of the at least one virtual computer on an unscheduled basis; a storage system; and a streaming video content system for separating streaming video data into a graphical user interface component that contains data display information required by said terminal device in order to locate and draw a user interface and a video stream component that is displayed on a screen of the terminal device within the user interface.

### RELATED APPLICATION

This application relates to and claims the benefit under 35 U.S.C. §119(e) of a U.S. Provisional Application No. 60/993,280 filed Sep. 10, 2007.

### TECHNICAL FIELD

This application relates to systems and methods for providing computer services and more specifically to systems and methods for providing computer services by a computer service provider to one or more computer users across a network.

### BACKGROUND

Over the last 10 years there has been a rapid creation and expansion of computer service providers who in general offer to provide computer resources to a computer user or users across the Internet. These computer service providers are referred to by several different names, for example: Application Service Provider (ASP), Software as a Service (SaaS), Hosted Service Provider (xSP), and Internet Service Provider (ISP). The characteristics that generally distinguish one type of provider from another provider being the type of resources and services being offered. An ASP in its most general sense is a business that provides computer-based resources and services, including hardware and software, to customers over a network, while a SaaS is generally referred to as a company that provides maintenance and technical support over a network for the software that the company provided to its client. An xSP, on the other hand, generally provides the same resources and services as an ASP and a SaaS, as well as providing traditional information technology functions such as infrastructure, security, monitoring, storage, website hosting and email. And, an ISP normally only provides a computer user with a connection to the public Internet, although it may offer some of the same serves as the other providers.

Regardless of the type of computer service provider that is providing the resources and services to computer users, the general model is that the computer provider operates a server computer, usually a large capacity computer such as one or more single-frame computers or “servers”, that serves computer resources and services over a computer network, either the public Internet or a private network, to multiple computer users who are individually operating a client computer, normally a personal computer (PC). In this service provider model, the PC will generally consist of at least a central processing unit (CPU) for executing application programs, a general application operating system such as Microsoft Windows®, primary storage or memory (RAM), a secondary storage device such as a hard drive, an input device such as a keyboard and/or mouse, an output device such as a monitor and/or printer, and device drivers for operating the input and output devices.

With respect to providing software applications from a service provider that is providing services over the Internet, at the user's request a web server, in conjunction with associated application and database servers, sends a requested application (e.g. Microsoft Word®) in web-enabled form over the Internet to the user's computer, where a web browser translates the web-enabled application back into a user compatible form. The application is then normally stored in the PC's memory for execution by the user, who is authorized to continue to use the application for some period of time established in an agreement between the provider and user. This process only functions for web-enabled applications that have been previously reprogrammed to support this model. The primary goal of this application delivery system is the presentation of applications to a PC and not the complete elimination of that PC and its general application operating system.

Although there are numerous, well known advantages and disadvantages in a network based or HTTP/HTML protocol based application service model (referred to herein as a Client/Server model or Web-Centric model), one significant disadvantage that has not been previously emphasized relates to the user's computing experience. When a computer user operates a PC in a stand-alone configuration (i.e. not operating in a Client/Server configuration), the user interacts with a user interface in order to obtain full access to all of the functionality of his or her desktop environment. In a Windows® environment, for example, the user interface provides the user with the ability to use input/output devices, access resources on remote networks, interact with a complete desktop windowing environment (such as X Windows or Microsoft Windows Explorer) and any and all applications which have been written for that operation system and desktop windowing environment. Unfortunately, in the Client/Server model, it is not possible to provide the computer user with same desktop environment as in the stand-alone model because of the intermediary steps of rendering the application into HTML, delivering it over HTTP and interpreting that HTML code in a limited functionality client application called a Web Browser, such as Microsoft Internet Explorer, Apple Safari, Mozilla Firefox and Netscape Navigator. Typically the following functions are not provided in the service provider or Client/Server configuration: ability to run applications written for a specific operating system and desktop windowing environment without modification; interact with user interface elements which are exactly the same as the interface elements of a desktop environment as it would appear in a stand-alone PC configuration; and use a complete externally hosted desktop windowing environment (such as X Windows or Microsoft Windows Explorer) and share input/output devices with the remote server (such as USB serial and parallel ports and audio). The obvious disadvantage that is a result of this difference is that the user does have full access to all of functions provided by the remote computer to remove the dependency on having a fully functional stand alone PC which has to be maintained by locally available or remote computer support staff.

Another significant limitation in the Web-Centric model as it is implemented by a service provider is that there is an inherent limitation in the need for computing resources as well as staff on both the Client side and Server side. Since PCs are still required in the Web-Centric model, the same computer support paradigm is required. Centralized staff is easier and cheaper to manage, but PC installations require unique operating system installations, applications and settings depending upon the type of PC being used, meaning that the PCs will all be subtlety or drastically different than one another. The difference in these PCs accounts for the bulk of the estimated 4-5 times multiple above acquisition cost that is required to maintain a given PC for the life of the PC. This is a serious limitation which was not considered during the move away from centralized computing using a shared computer to distributed computing using stand alone PCs, and now back to a type of centralized computing using PCs as part of the Web-Centric model. Further, network bandwidth accounts for another large percentage of the overhead costs associated with a Web-Centric PC installation. All objects, such as files, that are downloaded to a given PC need simultaneous and rapid network communication for optimal performance. When several users are downloading a large file at the same time, each one of them will demand all available network communication capability, and unless a network device manages the competing user demands, substantial bottlenecks will arise in the network connection, such as in the Internet or a private Wide Area Network (“WAN”). In most instances, the bottlenecks would arise at the point where the Internet or private WAN connection reaches the users' PCs. In addition, companies and home users spend substantial amounts of time and money and must accept significant amounts of lost productivity when using a stand-alone PC or a Web-Centric model. A high degree of expertise is needed to keep PCs operating. This task is becoming more difficult as the amount of software updating to combat malicious code coming from the Internet has increased. Today, a Microsoft Windows user typically has several security applications (Anti-Virus, Anti-Spyware and Anti-Popup) that are periodically automatically updated. In addition to this updating, the user will periodically receive operating system patch updates and other third party application updates happening all at the same time. All of this patching is leading to instability in computers and takes productivity away from users. Finally, lost or stolen computers present a serious risk for companies as well as home users, a risk not just to the loosing a physical computer but, potentially more important, loosing all of the users personal and confidential information as well.

Many of the limitations in the Web-Centric model discussed above are addressed in U.S. Pat. No. 7,036,006 (‘006 patent’) issued to Jagadish Bandhole, et. al. The '006 patent discloses a client-server architecture in which “computing resources and the activity of computing [are] provided to a user as a packaged product as well as a service. A platform can be any combination of hardware and software components or other resources” (Column 4, lines 6-10). The patent further explains that the invention enables a “customer” or “system architect” to design “a system by allocating resources and specifying how those resources are to be used” (Column 4, lines 36-38). “The system is referred to as . . . a “computing environment” and the primary provider [i.e. service provider] of such an environment is referred to as an Environment Service Provider (ESP)” and the ESP “obtains revenue for providing the resources and the tools to easily select, allocate, configure, and run the [computing] environment” (Column 4, lines 39-46). A more detailed description of the client-server architecture is set forth in FIG. 2 of the '006 patent. The figure and the accompanying written description disclose the utilization of a plurality of “Web Servers”, comprising a “Web Tier 205” (Column 8, lines 49-55), which is typically utilized by all application providers.

FIGS. 1A and 1B and the detailed description of the '006 patent generally describe and illustrate that the computing environment consists of a computer system which include, among other things, a cabinet which houses a disk drive, CDROM drive, display adapter, network card, random access memory (RAM), central processing unit (CPU), and other components, subsystems and devices. In this regard, the patent states that “[a]ny hardware platform suitable for performing the processing described [in the specification] is suitable for use with the present invention” (Column 7, lines 15-17). The patent further describes that the invention comprises a “framework that enables configuring, provisioning and managing DCEs [Dynamic Computing Environments] remotely” and that “configuring a DCE involves choosing the resources and their interconnections” (Column 6, lines 24-27). Additionally, the patent provides that “[p]rovisioning a DCE involves [the] allocation of physical resources required for a DCE to function” and that the “present invention manages the physical resources needed for provisioning DCEs and supports operations for allocating/deallocating these resources” (Column 6, lines 32-36). Furthermore, the patent discloses that the computing environment is made available to the user on a “time sharing” basis, and the claims describe “an interface to accept user inputs for scheduling computer sessions” (Column 5, lines 31-37; and Column 12, lines 59-60), which the specification further describes as providing the user with the ability to “schedule a period of time for computing” and to “reserve the required resources and provide a guarantee to the customer on availability” (Column 11, lines 21-24).

Although the '006 patent discloses technology that ostensibly allows the remote delivery of a wide range of computer resources to a remote user, the use of the framework described in the patent to configure and manage the DCE gives rise to several significant limitations related to the usability of the framework by a business and a home user. As described in the patent, the DCE is essentially a hosted version of a local facility computer network. By this it is meant that the DCE includes database servers, file servers and PCs which communicate together over a network, which is pre-programmed to be logically constructed on a scheduled basis. Thus, in the DCE environment the quantity of dedicated hardware for a specific time period is high and the number of users who can share the physical hardware is necessarily limited to the number of time slots that can be sold within a given period of time (e.g. 24 hours), which must necessarily be further limited due to the time needed to reconfigure the DCE between users. For example, if four (4) hour time slots are sold, the system could only support a maximum of six (6) different users in a twenty-four (24) hour period, meaning that those persons would have to share the cost of the entire system. What is more likely is that during peak business hours (usually 8 AM-6 PM), there will be a high demand for such systems on an unscheduled and random access basis, with the result that a any customer, in order to ensure that it has continuous access to the computing resources, would need to reserve for that entire block of time and, therefore, pay for the bulk of the system. Although the customer gets the resources it needs, the customer was forced to do so by scheduling those resources in advance and paying a premium for the exclusive use of those services; obviously, other potential users do not get to use those same resources while they are reserved to another user.

Further, the detailed description and the figures in the '006 patent disclose the utilization of “Web Servers” as part of the framework for creating the DCE (Column 8, lines 51-55; lines; 64-66; FIG. 2, components 205; and FIG. 3, component 309). In this regard, it is reasonably inferred from the use of Web Servers that the expense of operating the system disclosed in the '006 patent will be relatively high as compared to a system that is not web based, because of the associated costs of acquiring, operating, and maintaining the Web Servers and all of the PCs that are needed to support this web based model. Further, it immediately follows from this inference that the applications served must be “web enabled” or reprogrammed versions of common applications. This requirement limits the number of applications that can be used and keeps the total system support cost high.

Another significant limitation disclosed in the '006 patent relates to the time needed to create the DCE. The patent provides that a customer's dedicated DCE can be “created from the same resources within minutes or even seconds” (Column 5, lines 28-31). It may also be inferred from a reading of the patent's description of the DCE, however, that the actual time needed to allocate and configure the resources needed to create a DCE will generally be several minutes because network addresses and other identifying information must be changed completely between the time when one user's time slot ends and another user's time slot begins. Although this down time may appear to be relatively short in duration and easily hidden from customers due to the system's inherent need to schedule computing resources, over the life of those resources the down time adds up to a significant operational expense.

Accordingly, what is needed is remotely available computing resources that do not need to be scheduled in advance in that the resources are randomly and substantially instantaneously available to all users, who can use the resources for a substantially indefinite time; that do not need to be continuously reconfigured; that do not need to provide complex PC support on the client side; and that can run any unmodified desktop application, including the provision of local USB, sound, video, keyboard, mouse, serial, parallel and other ports to users. These needs are satisfied by the system and method described in the specification below.

### SUMMARY

A computer system for providing computer services to a user, comprising: a virtual computer system comprising at least one virtual computer that is created within the virtual computer system, said virtual computer having a virtual operating system, a unique virtual computer identifier, and with said virtual computer provided for receiving input from and sending output to a terminal and peripheral device system that is remotely connected to the virtual computer system over a network ; a virtualization layer enabling the at least one virtual computer to utilize CPU, RAM and storage of a host computer within the virtual computer system; a virtual computer selector providing for the selection of the at least one virtual computer on an unscheduled basis; a storage system containing at least one virtual application program with the storage system in communication with the at least one virtual computer, said storage system for the delivery of said virtual application program to said virtual computer; and a streaming video content system for separating streaming video data into a graphical user interface component that contains data display information required by said terminal device in order to locate and draw a user interface and a video stream component that is displayed on a screen of the terminal device within the user interface.

The terminal and peripheral device system comprising at least one terminal device that is remotely connected to and in communication with the virtual computer system, said terminal device having an operating system that is functionality limited to providing output to and receiving input, including streaming video data, from the virtual computer system, which system executes user application code and stores all non-streaming data, said terminal device not having an operating system capable of executing application code and not having a access to storage within the device, said terminal device for use by the user to access the virtual computer selector in order to select the at least one virtual computer on an unscheduled basis and to use said virtual computer to access the at least one virtual application program that is made substantially instantaneously available to the user; and at least one peripheral device that is remotely connected to and in communication with the at least one virtual computer, enabling the user of the terminal device to use the peripheral device on an unscheduled basis, whereby the user of the terminal device is presented with a desktop experience while interacting with said virtual application program and said peripheral device.

### BRIEF DESCRIPTION OF THE DRAWINGS

FIG. 1 is a block diagram of the general architecture of the system and method for providing computer services.

FIG. 2 is a block diagram of the general architecture of the system and method for providing computer services illustrating the utilization of remote peripheral devices.

FIG. 3 is a block diagram of the general architecture of the system and method for providing computer services illustrating the virtual computer system.

FIG. 4 is a flow chart illustrating the creation of the virtual computer system.

FIG. 5 is a flow chart illustrating the creation of a user storage system and its use in the virtual computer system.

FIG. 6 is a flow chart illustrating the creation of a billing system and its use in the virtual computer system.

FIG. 7 is a flow chart illustrating a user's interaction with the system and method for providing computer services.

FIG. 8 is a block diagram illustrating a streaming video content system.

FIG. 9 is a flow chart further illustrating the streaming video content system.

### DETAILED DESCRIPTION OF PREFERRED EMBODIMENTS

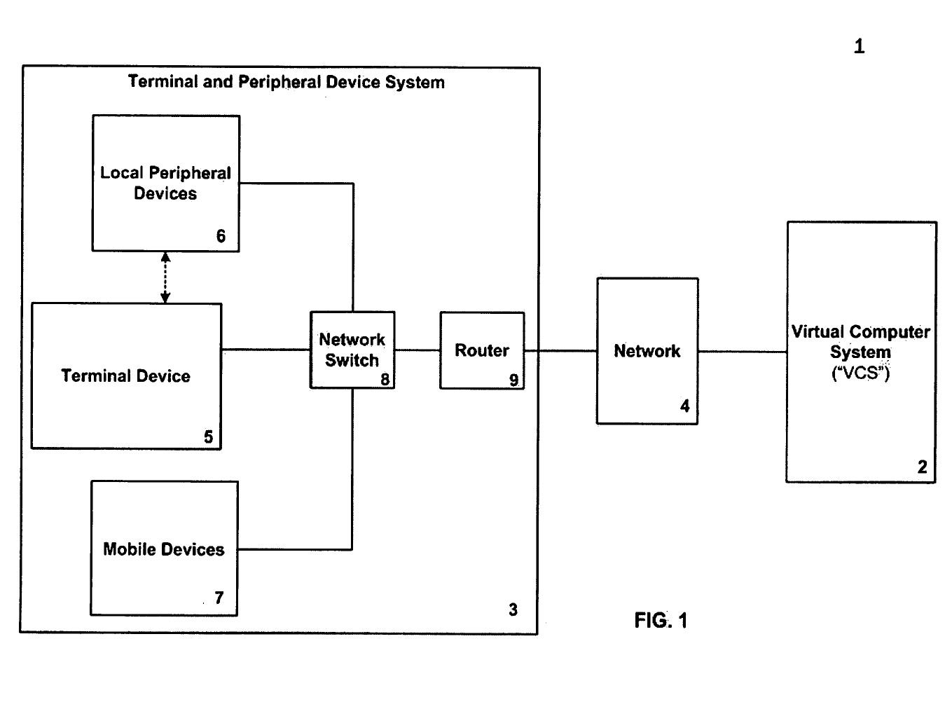

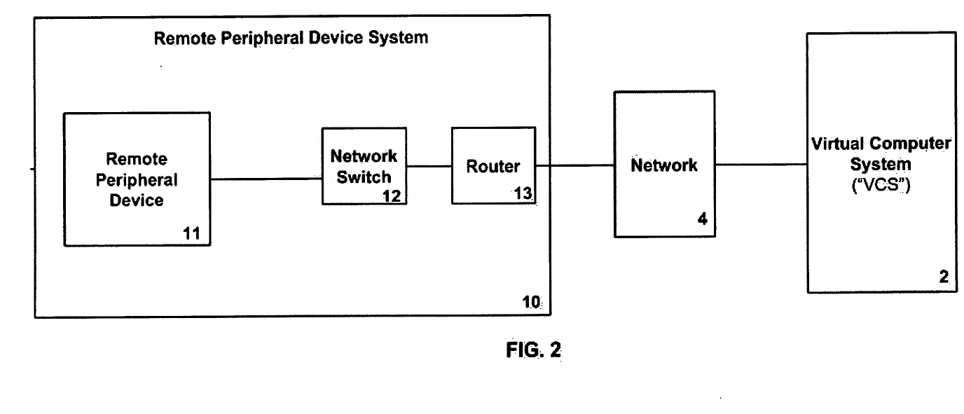

FIG. 1 illustrates a preferred embodiment of the general architecture of a computer system 1 for providing computer services, which includes a virtual computer system 2 and a terminal and peripheral device system 3, with each system in communication with the other by means of its connection over a network 4. For each user of the system 1, the terminal and peripheral device system 3 generally contains a terminal device 5, including a keyboard, and one or more local peripheral devices 6, such as printers, storage devices such as USB flash drives, and digital audio devices such iPods®, and possibly one or more mobile devices 7, such as a personal digital assistant or a laptop computer. As used in this specification, “local peripheral devices” means devices that are within the user's immediate physical environment. The terminal device 5, local peripheral devices 6, and mobile devices 7 are each connected to a network switch 8, which is connected to a router 9, which is connected to the network 4, which is connected to the virtual computer system 2. In another embodiment (not shown) at least one printer is connected directly to the terminal device 5, rather than being connected directly to the network switch 8. In another embodiment as illustrated in FIG. 2, the computer system 1 comprises a remote peripheral device system 10 in which one or more remote peripheral devices 11, of the same type described in connection with the terminal and peripheral device system 3, are connected to a network switch 12, which is connected to a router 13, which is connected to the network 4, which is connected to the virtual computer system 2. As used in this specification, “remote peripheral devices” means devices that are not within the user's immediate physical environment.

As used in this specification, the term “terminal device” means a computational device which provides the amount of a computational resource, such as CPU, RAM, and storage, required in order to execute an embedded operating system, which is functionally limited to providing input and output to and from a centralized computing system, which executes all application code and stores all non-streaming data; acceptable terminal devices include: Neoware e100, Neoware e370, Ntavo 6020p and Nokia 770. In this regard, a “terminal device” does not include a “personal computer” which means a computational device which provides the amount of a given computational resource, such as CPU, RAM and storage, for the purpose of executing a general operating system which has no functional limitations and executes all application code on its own CPU and stories all data within its own storage hardware. A “computational device” means any electronic device which has the capability of performing mathematical operations, performing logical tasks, and storing the results of those operations and tasks. A “desktop experience” means the appearance and functionality of virtual applications that appear and function on a terminal device exactly as if the programs were presented to a user of a “stand-alone personal computer”, meaning a computer that is not in communication with other computers or devices over a network and, thus, does not receive any of its computer resources from other computers or devices. A “network” or “network connection” includes any physical or logical link between two or more computational devices that allows for the devices to send input and receive output. Further, as used in this specification unless specifically stated otherwise, a “user” or a “network user” is a person who is obtaining some or all of his or her computer resources from other computers or devices on the network. As also used in this specification, “user application”, “user application code”, “application code”, “application”, or “application program”, all describe a software program that a user interacts with to perform a specific function. Examples of user applications include word processors, database programs, and Web browsers. A software program that a user does not interact with is not considered to be an application within this specification. In addition, “streaming video content”, “video content” or “video streaming content” and “video” all refer to data that is presented to a terminal device.

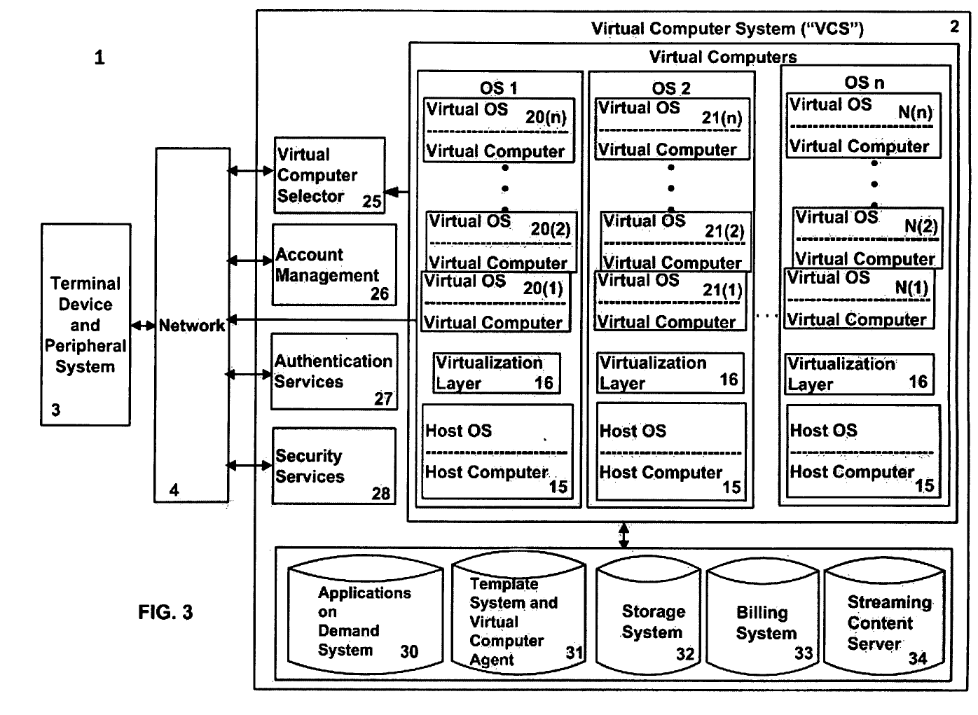

Referring now to FIG. 3, which illustrates in more detail the preferred embodiment of the virtual computer system 2, the system contains a programmed virtual computer selector 25 that receives information from the virtual computer system 2 and uses the network connection 4 in order to establish a communication with the terminal device and peripheral system 3. In general the virtual computer selector 25 provides a user of the terminal device 5 with various computer resource options, such as which operating system the user wants to use and in one embodiment the quantity of CPU, memory, and storage desired. Upon the user's selection of computer resources, the virtual computer selector 25 selects a virtual computer from a plurality of virtual computers for exclusive use by the user. The virtual computer system 2 also includes an account management programmed computer system 26 that is used to set up a user account for each user of the virtual computer system 2. An authentication services programmed computer system 27 is used to verify that a user who is attempting to log into the system 2 is authorized to use the computer resources provided by the system 2. In this regard, the authentication services system 27 contains a peripheral device database which identifies all of the terminal and peripheral devices that are registered with the virtual computer system 2 for use by an authenticated user. With respect the remote peripheral device system 10, the database also contains Global Positioning System (“GPS”) information which identifies the physical location of each of the remote peripheral devices 11. A security services programmed computer system 28 is provided to ensure that the each user of the virtual computer system 2 is provided with a secure connection to the network 4.

In the preferred embodiment, the virtual computer system 2 further includes a plurality of identical host computers 15 with operation and control of each of the host computers provided by utilizing an identical host operating system 16. An acceptable host computer out of the plurality of host computers 15 is Sun Microsystem's x86 Blade® System, and an acceptable host operating system 16 may be, for example, a version or derivation of the Linux operating system which has multi-core/multi-processor support, 64-bit support, USB audio support and other modifications to allow for efficient and high volume virtual computer operation. Associated with each host computer out of the plurality of host computers 15 is a virtualization layer 17 which is a software program that in general enables a virtual computer and its associated virtual operating systems to utilize the CPU, RAM and storage of the host computer. An acceptable program for the virtualization layer 17 is VMWare Server GSX® by VMWare. Further, each of the host computers out of the plurality of host computers 15 has associated with it a plurality of virtual computers, with each virtual computer having a predetermined virtual operating system. For example, as illustrated in FIG. 3, one of the host computers from the plurality of host computers 15 is associated with a first set of a plurality of identical virtual computers, with each virtual computer within the first set having an identical virtual operating system (e.g. a virtualized version of Microsoft Windows®), illustrated in the figure as Virtual Computer/Virtual OS 20(1), Virtual Computer/Virtual OS 20(2) . . . Virtual Computer/Virtual OS 20(n). Similarly, another one of the host computers out of the plurality of host computers 15 is associated with a second set of a plurality of identical virtual computers, with each virtual computer within the set having an identical virtual operating system, which is different from the virtual operating system serving the first set of identical virtual computers, (e.g. a virtualized version of Unix®); these virtual computers and their associated virtual operating system are illustrated in the figure as Virtual Computer/Virtual OS 21(1), Virtual Computer/Virtual OS 21(2) . . . Virtual Computer/Virtual OS 21(n). The number of unique sets of identical virtual computers is equal to the number of different types of virtual operating systems that are included within the virtual computing system 2; these sets of virtual computers are illustrated in FIG. 3 as Virtual Computer/Virtual OS N(1), Virtual Computer/Virtual OS N(2) . . . Virtual Computer/Virtual OS N(n). Further, the number of identical virtual computers within a given set of a plurality of virtual computers is only limited by the computing capacity of the host computer associated with the plurality of virtual computers. In this regard when the capacity of a host computer is about to be exceeded, the blade system that is utilized by the virtual computer system 2 has the feature of allowing the provider of the system to simply add another blade to accommodate the anticipated extra load. Although this feature is not expressly disclosed in FIG. 3 which illustrates a single host computer out of a plurality of host computers 15 which is associated with a set of identical virtual computers, the virtual computer system 2 includes the creation of multiple sets of identical virtual computers within each set.

With respect to the number of virtual computers that the computer system 1 will utilize, a statistical model can be used that will determine the number of virtual computers that are needed to service a certain number of anticipated users without any interruption in service. Initially, it is anticipated that a provider may want to provide a number of virtual computers in excess of the anticipated demand; then based upon the provider's experience, the provider may start oversubscribing users and still be able to substantially guarantee that the system will always be available to all users. In this regard, even if user demand exceeds the number of available virtual computers, the provider can quickly increase the number of available virtual computers by the addition of one or more blade servers that may be kept on hand for such events. The downtime needed to add a new virtual computer would be in the order of a few minutes, much less than the downtime experienced by users of personal computers when, for example, their hard drive crashes and their computer is inoperative for a day or for several days, which is more likely. In this regard, specific reference is made to a paper entitled “Piecewise Linear Approach to Overbooking” by Feng Lang, et. al., published in connection with the 2004 Workshop on High Performance Switching and Routing, in which the authors describe the application of a piecewise linear function to overbooking by network providers. The approach described the paper would be an acceptable statistical model to use in the system 1 described in this specification.

As further illustrated in FIG. 3, the virtual computing system 2 includes an applications-on-demand programmed computer system 30, a template programmed computer system 31, a computer storage system 32 and a billing programmed computer system 33. The applications-on-demand system 30 is provided in order to store in a file server each of the software applications that are potentially made available to a user. The applications may be made available to the applications-on-demand system by the owner and operator (generally referred to herein as the “provider”) of the virtual computer system 2 and/or applications may be provided to the applications-on-demand system 30 by the user. In either event, the account management system 26 records which applications a given user is authorized to use and provides that information to the applications-on-demand system 30. Before any application may be accessed by a user of the virtual computer system 1, however, the application must be “virtualized”, meaning that the application is launched using a separate computer and a virtualized application, including its virtualized application settings, is obtained by copying the application exactly as it appears in storage and storing the copy in the storage of the storage system server 32. The application to be virtualized is run in a virtual application execution environment (often called a “packager”) which acts as if it was the target virtual computer and operating system. The installation program is executed and the application to be virtualized copies files, establishes software/operating system settings, and generates standard configuration database entries; an example of an acceptable configuration database is Microsoft's Active Directory. All of these actions are captured into a virtualized application package which can be made available to other computers in a secure fashion while avoiding the need to install that application onto each virtual computer manually. This process also allows for security and authentication over the virtual applications so that the provider can ensure that only authorized users are able to launch a given application and enable the provider to launch that application from any of an interchangeable set of generic virtual computers based on system templates, described below.

A template system 31 contains copies or templates of each of the operating systems that the virtual computer system 2 makes available to a user. The operating system may be any system that is compatible with what is commonly called the Intel or x86 processor platform and includes all Microsoft Windows® versions, Unix®, Solaris® x86, MacOS X® (x86 version) and various Linux® distributions. In addition to these publicly available operating systems, the user may provide a customized operating system if needed to run a customer provided application, again so long as the operating system is compatible with the Intel x86 processor platform. As in the applications-on-demand system 30, however, before any operating system may be accessed by a user of the virtual computer system 2, the operating system must be “virtualized”, meaning that the operating system is launched using a separate computer and a virtualized operating system is obtained by copying the operating system exactly as it appears in storage and storing the copy as an operating system template containing the virtualized operating system in a version management sub-system within the storage system 32. Additional information and commonly used utilities/settings are added to the base operating system installation in order to complete the system template. These additional utilities include: operating system patches, anti-virus applications, anti-spyware applications, anti-malware applications, file encryption/decryption software and anti-popup software. Additional settings include: authentication information, network information, local logins/passwords and security settings. When a system template is complete and has been tested, it is given a version number and stored in the Version Management System which in turn keeps the actual files on the file storage system 32. As new operating systems, operating system patches, utilities and settings are tested, a new version of a given system template is generated, the new version is then stored in the version management system which in turn stores the files on the file storage system 32 and a link is established from this new version to the established current template location. The template system 31 is also used to update each operating system with new releases. At the same time that a virtualized copy of a given operating system is stored in the version management system, a non-virtualized copy of the operating system is stored in the storage system 32 and is used when creating base operating system installations. When a new operating system is released, the operating system virtualization process is repeated. When a patch is released, the current system template is loaded onto a separate computer, patches are installed, and the up-dated version is stored in the template system 31 as a new version and links to the current version are changed to point to it and the virtualized updated version is stored in the version management system of the storage system 32. In addition the template system 31 contains a virtual computer programmed agent that is registered with virtual computer selector 25. In general, the virtual computer agent monitors the operation of each virtual computer and, specifically, detects when a user logs off of a virtual computer so that the computer can be immediately made available to other users.

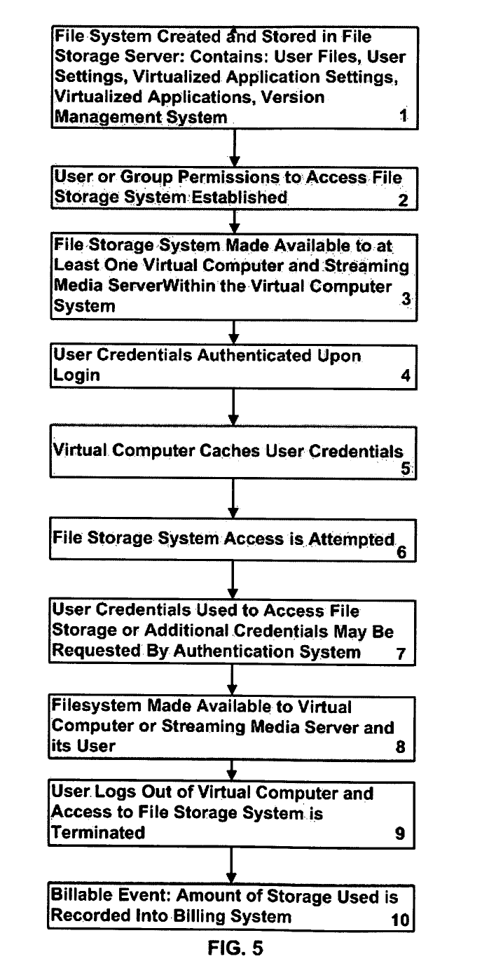

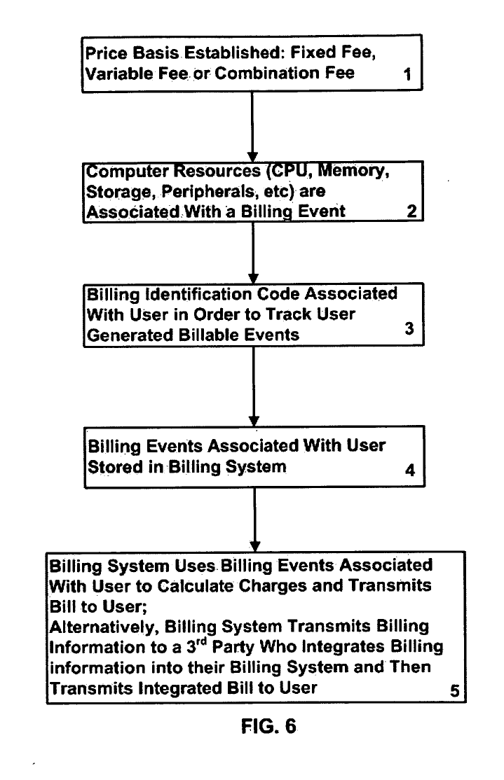

In addition to containing virtualized copies of all of the applications and their associated settings, the storage system 32, which is described in more detail in reference to FIG. 5, contains user files, user settings, and as described above, the version management system within the storage system 32 containing virtualized copies of each operating system offered by the virtual computer system 2. Lastly, the billing system 33, which is described in more detail in connection with FIG. 6, contains a record of the billing agreement between the provider of the system 1 and the user, and keeps track of the billable events that are used to calculate charges to be included in a bill that is sent to the user.

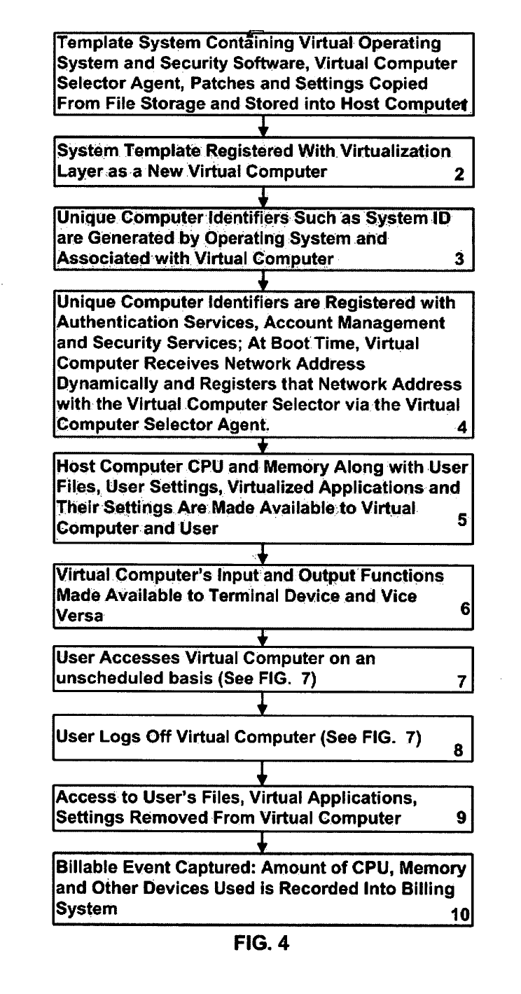

Turning now to FIG. 4, a flow chart describes the manner in which a single virtual computer is created, for example the creation of Virtual Computer/Operating System 20(1), and dedicated for the exclusive and unscheduled use by a user. Although the flow chart and the following description only describe the creation of a single virtual computer 20(1), the description also applies to the creation of all of the virtual computers contained within the virtual computer system 2. In step 1, the system template, containing the virtualized operating system and related software, such as patches, utilities, settings, and the virtual computer agent, is copied from the version management system of the storage system 32 and stored in a host computer out of a plurality of host computers 15. In step 2, the system template is registered with the virtualization layer 16 as a new virtual computer 20(1) which is in communication with the host computer, and the registration process can be repeated to create a plurality of virtual computers. In step 3, unique virtual computer identifiers, such as system ID are generated by the virtual operating system of virtual computer 20(1) and associated with the virtual computer 20(1). In step 4, other unique virtual computer identifiers are registered with authentication services 27, account management 26, and security services 28; and when the virtual computer 20(1) is started it receives a network address dynamically and the virtual computer agent registers the network address with the virtual computer selector 25. In step 5, the host computer's CPU, memory and storage along with applicable user files, user settings, virtualized applications and their settings, are made available to the virtual computer 20(1) and the user's terminal device 5. The quantity of CPU, memory and storage made available to the user is determined by the user's preferences for those resources that are recorded in the account management system 26 at the time the user registers with the system or at any time thereafter 1; alternatively, the user may elect to use predetermined default quantities of CPU, memory and storage. The virtualization layer 16 in conjunction with the account management system 26 keeps track of what resources a user is authorized to use and ensures that CPU, memory, storage and other computer resources are made available when requested by a terminal device 5 user. All settings, temporary files and other uniquely identified files that a user needs are either copied from the storage system 32 or read directly from the storage system 32 upon login and removed upon logout. In step 6, input and output functions of the virtual computer 20(1) are made available to the user's terminal device 5 and input and output functions of the terminal device 5 are made available to the virtual computer 20(1). In step 7 the user uses the terminal device 5 to access the virtual computer 20(1) on an unscheduled basis and obtains a desktop experience while using the applications that the user has been previously authorized to use. In step 8, when the user has finished using the applications, the user logs off of the virtual computer 20(1); and in step 9 the user's access to the user's files, virtual applications and settings is discontinued and the virtual computer 20(1) is then made immediately available for use by another user without reconfiguration. In step 10 each of the billing events, as described below in connection with FIG. 6, are recorded into the billing system 33.

FIG. 5 describes the storage system 32 and its use by a user operating a terminal device 5 in communication over the network 4 to a virtual computer within the virtual computing system 2. In step 1 a file system is created in the storage system 32, which contains: user files and settings for all users who have been authorized to use the computer system 1; all virtualized applications that are made available to users who are authorized to use some or all of the applications; and a version management system that contains templates of the most recent versions of each operating system that is used to create the virtual computers. In step 2, user or group permissions to access the files within the storage system 32 are established by the account management system 26. In step 3, the storage system 32 is made available to at least one virtual computer within the virtual computer system 2 by using one or several “file sharing protocols” such as Common Internet File Service (CIFS), Server Message Block (SMB) and/or Network File Services (NFS). In step 4, the user's credentials are authenticated by the authentication services system 27 at the time the user logs into the computer system 1, and at step 5 the virtual computer assigned to the user caches user credentials. In step 6, the user attempts to access files within the storage system 32, and at step 7, the user's credentials are checked by the authentication services system 27 and if necessary additional credentials may be requested by the authentication services 27. If authentication services system 27 approves the user's access to the storage system files, the files are made available to the virtual computer that has been dedicated to the user using a set of file sharing protocols. When the user logs out of the virtual computer system 2, as in step 9, the user's access to the storage system 32 is terminated. Then in step 10, the billable events related to the user's use of files from the storage system 32 are recorded into the billing system 33.

The billing system 33 is illustrated in FIG. 6. In step 1, a basis to charge a user for use of a virtual computer and its related resources is established. In the preferred embodiment several pricing options are made available. For example, the user may agree to pay a predetermined “fixed fee”, which may be charged as a “billing event” each time the user is provided with unscheduled exclusive access to a virtual computer, and the fee may be coupled with other predetermined fixed fees that are charged, for example, as billing events each time the virtual computer accesses the CPU and memory of the host computer and/or each time the user accesses an application or storage. From an economic standpoint, the fixed fee might be most advantages to single or group users who continuously use the systems resources for long periods of time. Alternatively, for single or group users who use the systems resources less often, it may be more advantages for those users to agree to pay a predetermined “variable fee”, which may be also charged as a billing event based upon how long the user is logged onto a virtual computer, and again the fee may be coupled with other predetermined variable fees that may be charged based upon how long the user uses CPU, memory and/or applications. Under both billing methods, the amount of the user's fee to use CPU may also be adjusted based upon the quantity of CPU that has been allocated to the user at the time the user sets up an account or anytime thereafter. Naturally, several different billing plans may be devised based upon combining features of the fixed and variable methods. In step 2, computer resources, such as CPU, memory, storage, applications, etc., are then associated with a “billing event”. In step 3, a billing identification code is associated with each user of the computer system 1 in order to track user generated billable events. Then in step 4, as a user interacts with a virtual computer, user generated billable events are stored in the billing system 33. In step 5, the billing system 33 uses the user generated billing events that are associated with the user to calculate charges for using the computer system 1 and the provider of the computer system 1 send a bill to the user for payment. Alternatively, if the provider of the computer system 1 also provides other billable services to the user and uses a third-party billing program to bill for those services, the billing system 33 transmits the billing event information, along with the associated calculation of charges, directly to the provider's billing package system where the charges for using the computer system 1 are integrated into the third-party billing program before being sent to the user.

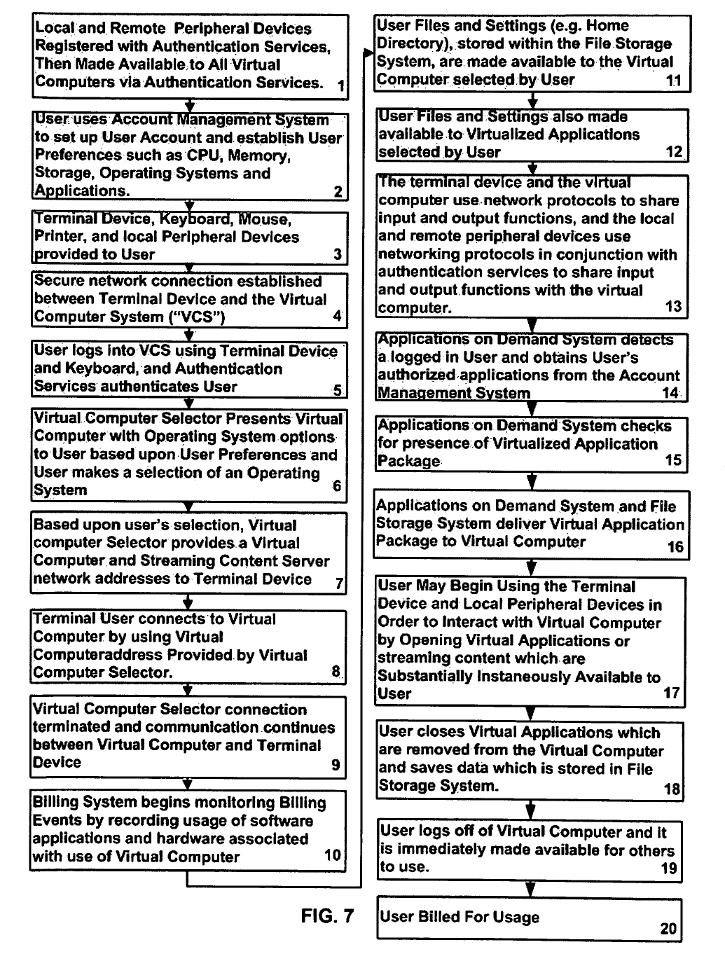

FIG. 7 presents a description of the user's use and interaction with the computer system 1 provider by a computer provider. In step 1, the local and remote peripheral devices, 6 and 11, respectively, are registered with authentication services 27, which in turn makes all of the peripheral devices available to virtual computers. In step 2, a potential user of the system 1 accesses the account management system 26 in order to set up a user account and to indicate the applications the user desires to use and the user's preference for the type of operating system the user desires to use from a pool of operating systems made available to the user. The user may also indicate the amount of CPU, RAM, storage or other hardware resources that the user would like to have access to; alternatively, the user may allow the account management system 26 to select default amounts of these resources. In step 3, if the provider accepts the potential user as a new user of the system 1, a terminal device, keyboard, mouse, printer and possibly other local peripheral devices 6, are provided to the user or acquired independently by the user. In step 4, a secure network connection is established between the user's terminal device 5 and the virtual computer system 2. In step 5, the user logs into the virtual computer system 2 using the terminal device 5 and keyboard and the authentication services system 27 authenticates the user and informs the virtual computer system 2 of the authenticated user's login. In step 6, the virtual computer selector 25 displays an interface on the user's terminal 5 where operating system options are presented to the user based upon the user's operating system and hardware preferences, and the user is prompted to select one of the operating systems. In step 7, based upon the user's selection of an operating system, the virtual computer selector 25 establishes an exclusive communication link between a virtual computer, for example Virtual Computer/Virtual Operating System 20(1), and the user's terminal device 5 to the user by providing the appropriate network address of the virtual computer to terminal device 5, thereby providing an unscheduled, dedicated and exclusive use of the virtual computer to the user. In step 8, the terminal user connects to the selected virtual computer by using the virtual computer's address provided by the virtual computer selector 25 and in step 9 the connection between the virtual computer selector 25 and the terminal device 5 is terminated. In step 10, the billing system 33 begins monitoring the billing events that are generated based upon the user's use of software applications and hardware, as more specifically described in connection with FIG. 6. In step 11, user files and settings (e.g. “Home Directory”) that are stored in the storage system 33 are made available to the virtual computer and to the terminal user. In step 12, user files and settings are made available to the virtualized applications selected by the user. In step 13, the terminal device 5 and the virtual computer use network protocols to share input and output functions, and the local and remote peripheral devices, 6 and 11, respectively, in conjunction with network protocols use authentication services in order to share input and output functions with the virtual computer. In step 14, applications-on-demand system 30 detects that a user has logged into the system 2 and obtains the user's authorized applications from the account management system 26. In step 15, applications-on-demand system 30 checks for the presence of a virtualized application package containing the user's selected applications. In step 16, the applications-on-demand system 30 and storage system 32 deliver the user's application package to the virtual computer. In step 17 the user may begin using the terminal device 5 and the local peripheral devices 6 in order to interact with the virtual computer by opening the virtual applications, which are substantially instantaneously made available to the user, and the user obtains a desktop experience while interacting with the virtual applications. Alternatively, the user may begin using a mobile device 7 and for example, a remote peripheral device 11 such as a printer, in order to interact with the virtual computer by similarly opening the virtual applications, which are substantially instantaneously made available to the user, and the user obtains a desktop experience while interacting with the virtual applications. In this regard, the authentication services system 27 is programmed to receive physical location information, such as GPS information, from the mobile device and uses the peripheral device database to locate the remote printer that is closest to the mobile device, and the printer is then made available to the user by authentication services. In step 18 when the user has finished using the virtual computer, the user closes the virtual applications, which are erased from the virtual computer, and saves any data, which is stored in the storage system 32. In step 19, the user logs out of the virtual computer and the virtual computer agent releases the virtual computer, which is then immediately made available to another user without reconfiguration. Finally, in step 20 the user is billed for using the virtual computer based upon the generation of billable events as more specifically described in FIG. 6 above.

The computer system 1 described above has several significant commercial applications and advantages over conventional systems. By utilizing a plurality of virtual computers, the system 1 does not require the utilization of physical hardware that must be set and configured for each user and then reconfigured for a different user. Rather, the “hardware” of the system 1 is the plurality of virtual computers which are, in effect, software implementations of the hardware the virtual computers emulate. In the preferred embodiment, the plurality of virtual computers are all simultaneously “live”, meaning that all of the virtual computers that are not in use are randomly, immediately and instantaneously made available to each authorized user of the system 1 when a user logs into the system 1, and further that a user may use a virtual computer for a substantially indefinite period of time. In conventional systems, as in the '006 patent referred to in the Background section above, there is a finite period of time (“within minutes or even seconds”) needed to configure each Dynamic Computing Environment and make it available to a user. Naturally, over the life of the computing equipment, this computer down time, which is needed to configure the environment before each user is given access to the system's resources, constitutes a significant expense to the operation of the system. This computer down time is completely eliminated in the computer system 1.

Another significant advantage of the computer system 1 is that the system creates a “desktop experience” for each network user of the virtual computers provided by the system 1. As a result, a user of the system 1, whose experience is primarily limited to the operation of a stand-alone computer system, will not need to learn and become comfortable with a new system, because the appearance, touch and feel, and functionality of the applications, including the use of a USB device, sound, video, keyboard, mouse, serial, parallel and other ports, provided by the system 1 will be identical to the appearance, touch and feel, and functionality that would have been obtained with the use of those same applications in a stand-alone computer. In this regard, the network user's ability to use a “terminal device”, rather than a “personal computer”, means that the substantial expense needed to acquire and continuously support a personal computer is eliminated.

A further advantage of the computer system 1 is that users of the system are not required to schedule computing sessions as in the '006 patent. The system disclosed in the '006 patent requires the scheduling of computer sessions because physical computers using a compatible operating system are required to run applications and the availability of the hardware is obviously limited. The system 1 does not schedule the use of specific hardware because of the system's use of virtual computers and due to the utilization of statistical modeling to ensure that there are always a sufficient number of virtual computers available based upon the number of authorized users. When the number of users approaches a predetermined, statistically calculated maximum value, additional virtual computers are simply activated in order to accommodate the anticipated additional users.

In another embodiment of computer system 1, video streaming content is processed so as to increase the frame speed at which the content can be displayed on terminal device 5. The virtual computer system 2 within computer system 1 utilizes a proprietary protocol which is similar in its video transfer method to standard network protocols, such as RDP, VNC, and NX, for delivering video content to terminal device 5 within the terminal device and peripheral system 3. These protocols are designed to send only differential screen data to a terminal device because this method uses the least amount of CPU, memory and low network resource for the most common computing tasks. As result, when streaming video data is sent from a virtual computer within virtual computer system 2 to a terminal device screen, the screen data must be continuously and rapidly updated, placing a high demand on CPU memory and network resources within the virtual computer and giving rise to unacceptably slow video frame transmission rates. In addressing this problem, the inventors have noted that modern windowing operating systems include a windowing system and libraries that separate the function of screen drawing (e.g. displaying a graphical user interface (“GUI”) on a terminal screen) from the function of video drawing (e.g. displaying or rastering the video content within the GUI). In other words, the operating system components that draw the GUI windows are separated from the rastering operation that takes place within the boundary of the windows; an example of this drawing operation is the DirectX library from Microsoft for Windows products. Therefore, the inventors realized that the operation of drawing a window of a specific size and displaying the window at a specific location on a terminal device screen could be performed before the rastering operation. This realization lead to the creation of a streaming content system within the virtual computer system 2 providing for an increase in video frame transmission rates from a virtual computer to a terminal device of about 6 frames/second to about demand 30 frames/second.

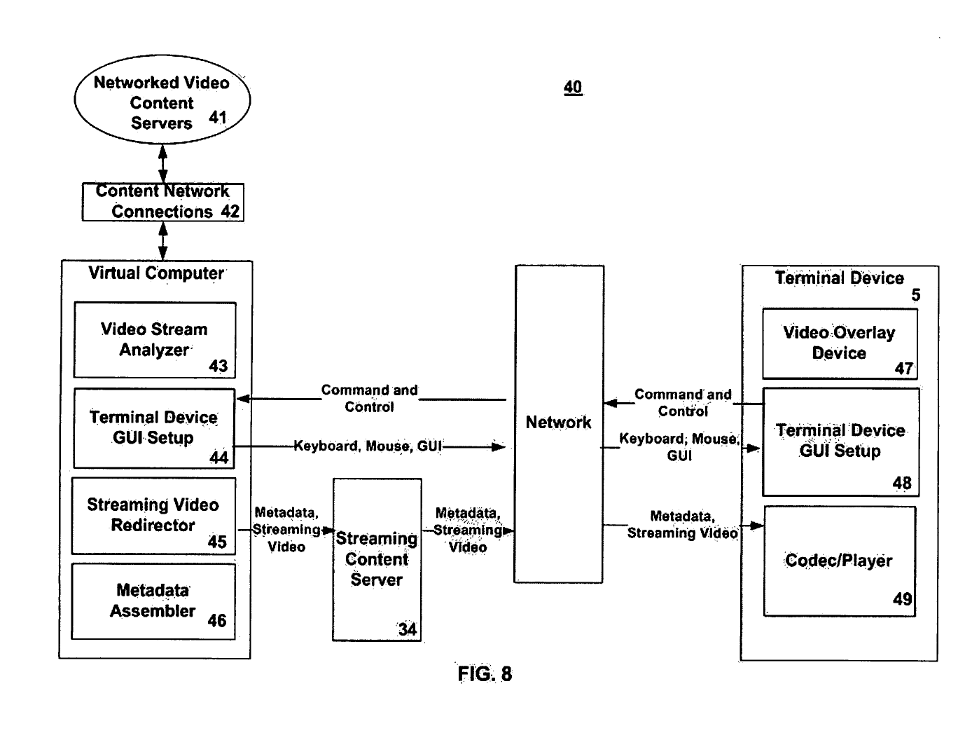

The flow chart illustrated in FIG. 7 and the computer architecture illustrated in FIG. 8 describe the streaming content system 40 within virtual computer system 2. Networked video content servers 41, existing outside of virtual computer system 1, have video content stored in memory that is generally available for access by users over content network connections 42 connected to the Internet. Content networked connections 41 are, in turn, connected to the virtual computers within the virtual computer system 2. Each virtual computer contains a software program that provides for, among other things, the separation of video streaming content into both a GUI data component and a video stream data component. More specifically, a video stream analyzer 43 determines whether video stream data is being sent to the memory of virtual computer and, if so, analyzer 43 separates the video stream data into to data components: a GUI component that contains all display information required to locate and draw the user interface of an video display application and a video stream component that contains compressed video data which requires a decoder to properly display said video on a display. In addition, video stream analyzer 43 determines what type of codec format has been used to encode the video stream component and what bit rate has been used for the incoming video stream, and this information is sent by analyzer 43 to a metadata data assembler 46 software program. A terminal device GUI setup 44 software program within a virtual computer sends commands that describe how and where to draw the video display applications' GUI over network 4 to a terminal device, such as terminal device 5 within the terminal device and peripheral system 3, instructing terminal device 5 to draw a GUI on the screen, and GUI set up 44 provides metadata assembler 46 with height and width data, as well as x and y coordinates applicable to the GUI. Further, terminal device GUI setup 44 within the virtual computer provides keyboard, mouse, and peripheral communication over network 4 to and from a terminal device GUI setup 48 software program within terminal device 5 and receives and executes instructions received from the command and control communications from the terminal device GUI setup 48 software program.

A streaming media redirector 45 software program within a virtual computer is in a network connection with a streaming content server 34 which gathers all metadata and compressed video streaming information and manages communication with the terminal device 5 via network 4. Metadata assembler 46 is also for assembling the data it receives from video stream analyzer 43 and providing the data to streaming media redirector 45, which in turn provides the data to the streaming content server 34 that then communicates over network 4 to codec/player 49 within terminal device 5. A video overlay device 47 is for rendering the streaming video within terminal device 5 and for presenting the data to the display connected to the terminal device 5.

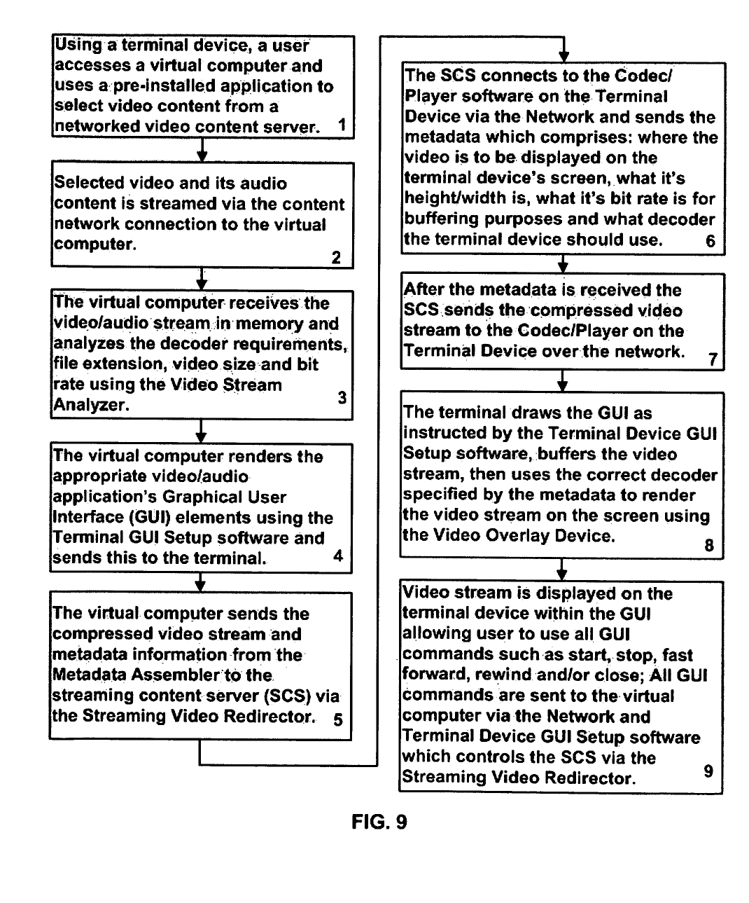

FIG. 9 is a flow chart illustrating the operation of streaming content system 40. At step 1, a user using terminal device 5 accesses a virtual computer within virtual computer system 2 and user selects video content from a networked video content server 41 using a web browser such as Internet Explorer or other pre-installed virtual computer program such as Windows Media Player that will download the video stream. At step 2, the selected video content is streamed from content network to a virtual computer within the virtual computer system 2. At step 3 the virtual computer stores the video content in memory and using video stream analyzer 43 analyzes the video stream's decoder requirements, file extension, video size and bit rate using video stream analyzer 43. The virtual computer at step 4 renders the appropriate video application's graphical user interface (“GUI”) and sends it to terminal 5 using terminal device GUI setup 44 software program. Next, at step 5 the virtual computer sends the compressed video content stream and the metadata information from metadata assembler 46 software to streaming content server 34 within virtual computer system 2 via streaming video redirector 45, which opens a socket connection to server 34 that in turn opens a network connection to a predetermined port on terminal device 5. At step 6 the streaming content server 34 connects to codec/player 49 software on terminal device 5 and sends the metadata received from the metadata assembler 49 which comprises: where the video data is to be displayed on the screen for terminal device 5, what is the data's height and width, what is the data's bit rate for buffering purposes, and what decoder terminal device 5 should use.

At step 7 streaming content server 34 sends the original compressed video stream to codec/player 49 software within terminal device 5 over the network. Terminal device 5 draws the GUI as instructed by the terminal device GUI setup 48 software at step 8, and then buffers the video stream and then uses the correct decoder specified by the metadata to render the video stream on the screen using video overlay device 47. Lastly, at step 9 the video stream is displayed on terminal device 5 within the GUI, allowing the user to us all GUI commands, such as start, stop, fast, forward, rewind, and/or close. All GUI commands are sent to the virtual computer that via terminal device GUI setup 44 software that controls streaming content server 34 via streaming video redirector 45.

Although the computer system 1 has been described in its preferred embodiment and in certain other embodiments, it will be recognized by those skilled in the art that other embodiments and features may be provided without departing from the underlying principals of those embodiments. The scope of the invention is defined by the appended claims.

We claim:

1. A computer system for providing computer services to a user, comprising:
a) a virtual computer system comprising
at least one virtual computer that is created within the virtual computer system, said virtual computer having a virtual operating system, a unique virtual computer identifier, and with said virtual computer provided for receiving input from and sending output to a terminal and peripheral device system that is remotely connected to the virtual computer system over a network;
a virtualization layer enabling the at least one virtual computer to utilize CPU, RAM and storage of a host computer within the virtual computer system;
a virtual computer selector providing for the selection of the at least one virtual computer on an unscheduled basis;
a storage system containing at least one virtual application program with the storage system in communication with the at least one virtual computer, said storage system for the delivery of said virtual application program to said virtual computer; and
a streaming video content system for separating streaming video data into a graphical user interface component that contains data display information required by said terminal device in order to locate and draw a user interface and a video stream component that is displayed on a screen of the terminal device within the user interface.
b) the terminal and peripheral device system comprising
at least one terminal device that is remotely connected to and in communication with the virtual computer system, said terminal device having an operating system that is functionality limited to providing output to and receiving input, including streaming video data, from the virtual computer system, which system executes user application code and stores all non-streaming data, said terminal device not having an operating system capable of executing application code and not having a access to storage within the device, said terminal device for use by the user to access the virtual computer selector in order to select the at least one virtual computer on an unscheduled basis and to use said virtual computer to access the at least one virtual application program that is made substantially instantaneously available to the user; and
at least one peripheral device that is remotely connected to and in communication with the at least one virtual computer, enabling the user of the terminal device to use the peripheral device on an unscheduled basis, whereby the user of the terminal device is presented with a desktop experience while interacting with said virtual application program and said peripheral device.

2. The computer system of claim 1 further comprising a statistical model for use in determining the number of virtual computers needed to service an anticipated number of users.

3. The computer system of claim 1 in which the at least one virtual computer is allocated a predetermined quantity of CPU from the host computer.

4. The computer system of claim 1 in which billing events associated with the user's interaction with the at least one virtual application program are stored in a billing system for use in generating a bill to be sent to the user.

5. The computer system of claim 1 in which the at least one peripheral device is a local peripheral device.

6. The computer system of claim 1 in which the at least one peripheral device is a remote peripheral device.

7. A method for providing computer services to a user, comprising:
a) creating at least one virtual computer within a virtual computer system, said virtual computer having a virtual operating system, a unique virtual computer identifier, and with said virtual computer providing for receiving input from and sending output to a terminal and peripheral device system;
b) connecting the virtual computer system to the terminal and peripheral device system over a network;
c) enabling the at least one virtual computer to utilize CPU, RAM and storage of a host computer;
d) storing at least one application program in a storage system that is in communication with the at least one virtual computer;
e) limiting the functionality of a terminal device within the terminal and peripheral device system to providing output to and receiving input, including streaming video data from the virtual computer system, which system executes all application code and stores all non-streaming data, said terminal device not having an operating system capable of executing application code and not having access to storage within the device;
f) enabling the user of the terminal device within the terminal and peripheral device system to use the device to establish on an unscheduled basis a remote connection between the device and the at least one virtual computer within the virtual computer system and to use said virtual computer to access the at least one virtual application program that is made substantially instantaneously available to the user;
g) enabling the user of the terminal device to use the at least one virtual computer to establish on an unscheduled basis a remote connection between said virtual computer and at least one peripheral device;
h) presenting the user of the terminal device with a desktop experience while interacting with said virtual application program and said peripheral device; and
i) releasing the at least one virtual computer when the user terminates the connection between the terminal device and the at least one virtual computer.
